(19) United States
(12) Patent Application Publication
(10) Pub. No.: US 2012/0257245 A1
(43) Pub. Date: Oct. 11, 2012

(54) AUTOSELECTED PRINT PATHS

(76) Inventors: Phillip A. McCoog, Portland, OR (US); Brian P. Schmitz, Garden City, ID (US); Scott A. White, Boise, ID (US)

(21) Appl. No.: 13/082,902

(22) Filed: Apr. 8, 2011

(51) Int. Cl. G06F 3/12

(52) U.S. Cl. 358/1.15

(57) ABSTRACT

A method for autoselecting a print path includes autoselecting a connection path between a computing device and a printer from an ordered connection list stored in a memory of the computing device and communicating image data from the computing device to the printer over the autoselected connection path using communication hardware.

### BACKGROUND

As electronic interconnectivity increases, multiple connection paths can exist between two computing devices. For example, a computing device support a wired network connection, a wireless network connection, wireless direct connection, and a cellular cloud connection to a printer. The configuration and selection these connection paths to the printer can significantly complicate the experience of the user. Conventionally, when configuring a printer, the user separately generates printer configurations for each of connection paths. When the user prints data to the printer, the user is forced to choose only one of the connection paths. However, the user may not be aware which connection path is most efficient and cost effective in delivering the data to the printer. Further, the selection of the printer configuration is an additional step in the printing process.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an illustrative network with multiple connection paths between a mobile computing device and a printer, according to one example of principles described herein.

FIG. 2A is a flowchart of an illustrative method for printing using an automatically selected connection path to a printer, according to one example of principles described herein.

FIG. 2B is a flowchart of an illustrative method for printing using an automatically selected connection path to a printer, according to one example of principles described herein.

FIG. 3A is a diagram of illustrative components within a computing device and a target printer, according to one example of principles described herein.

FIGS. 3B and 3C are illustrative examples of a connection list and an ordered connection list, respectively, according to one example of principles described herein.

FIGS. 4A and 4B are illustrative examples of printing using an automatically selected connection path to a printer, according to one example of principles described herein.

Throughout the drawings, identical reference numbers designate similar, but not necessarily identical, elements.

### DETAILED DESCRIPTION

As interconnectivity between computing devices increases, multiple connection paths can exist between two computing devices. For example, a computing device may be connected to printer through any of a number of connection paths. In addition to a wired connection, the computing device and/or printer have wireless capabilities such as Bluetooth or infrared transceivers, Wi-Fi, WiMax, GSM, PCS, or other wireless communication capabilities. Additionally, this connection hardware may be used to connect to a printer through a wide variety of networks. Consequently, there may be many different connection paths between the computing device and the printer.

Conventional installation of the printer on the computing device involves the user generating different printer configurations for each of the possible connection paths. When the user desires to print data on the printer the user is forced to evaluate which of the connection paths are most suitable and select the corresponding printer configuration. However, the user may not be aware which of the connections are available, most efficient, or cost effective in delivering the print data to the printer. Further, the selection of a printer configuration is an additional step in the printing process and complicates the user's workflow. The user may be confused by the options or may consistently select the same print path regardless of the circumstances. This can significantly reduce the value and flexibility provided by the alternative connection paths.

The illustrative systems and methods described below automate and simplify the installation and connection process for printers by autoselecting a “best” connection path between the computing device and the printer. This solution does not depend on input from the user and significantly improves the user experience. When the user selects a target printer, the system automatically routes the print job to the target printer using the “best” connection path. The significantly reduces the user effort in installing the printer, streamlines the user's printing experience by eliminating steps, can result in faster connection speeds and provides increased flexibility in printing through alternative routes.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples.

As used in the specification an appended claims, the term “connection path” refers to a possible communication channel between a computing device and a printer. The connection path may or may not be accessible at any given time or location. The term “autoselect” refers to connection paths that are chosen by a computing device and tested for availability. The autoselection process is transparent to the user of the computing device. The term “ordered list” or “ordered connection list” refers to a list of connection paths in a data table that are organized according to criteria, with the location of the connection paths within the data table being determined by their level of conformity with the criteria. The term “rank” refers to a measurement of the level of conformity of the connection paths with the criteria. The term “image data” refers to any data that is, or can be, printed.

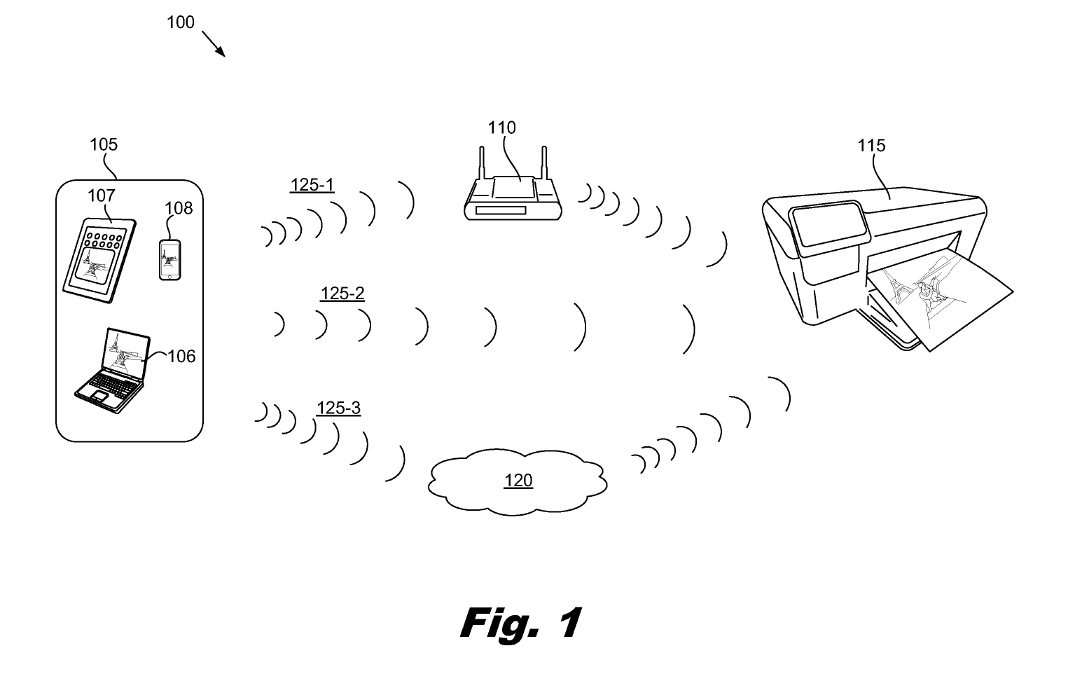

FIG. 1 is a diagram of an illustrative network (100) with multiple connection paths (125) between computing devices (105) and a printer (115). The computing devices (105) may include a wide variety of computing devices, including desktops, laptops (106), tablet computers (107), mobile devices (108) and other network enabled devices. One or more connection paths (125) to a printer (115) may be available to the computing devices (105). To make a viable connection between a computing device (105) and the printer (115), the computing device (105) is powered up and has the hardware/software capability to support the connection. If there are intermediate devices in the connection path, the intermediate devices are available to transfer the communications. The printer (115) is also powered up, connected to the appropriate connection path and ready to receive image data.

A first connection path (125-1) includes wireless communication between one of the computing devices (105) and passes through a wireless access point (110). The wireless access point (110) includes one or more radios that establish two-way communications with a wireless radio in the computing device. The wireless access point (110) may have a wired or wireless connection with the printer. In this example, the printer is wireless enabled and the wireless access point (110) connects to the printer using a wireless connection.

A second connection path (125-2) is a peer-to-peer wireless connection. The peer-to-peer connection (125-2) could made using a variety of technologies, including ad-hoc wireless connections, Wi-Fi, Wi-Fi direct, Universal Serial Bus (USB) wireless, Wi-Max, infrared, Near Field Communication (NFC) or other wireless connection technology. The peer-to-peer connection (125-2) may have a number of advantages including the ability to directly connect to the printer (115) without having to authenticate on a network or pass through other intermediate devices. This can create a relatively simple and secure connection path. The peer-to-peer wireless connection (125-2) could have several limitations, including a short transmission range and a relatively low connection speed.

A third connection path (125-3) is made through a cloud (120). As used in the specification and appended claims, the term “cloud” refers to networks and technology that support communication between non-analogous networks. When connecting through the cloud (120), the computing device (105) doesn't know the exact connection path to the printer (115), and vice versa. However, the connection is made using the cloud capabilities to connect and translate between whatever network connections are being used. In one implementation, the computing devices (105) may send printing requests and data to a predetermined Universal Resource Locator (URL) or Internet Protocol (IP) address in the cloud (120). The printer (115) registers with the IP network so that communication and data sent to the predetermined URL or IP address is forwarded to the printer (115).

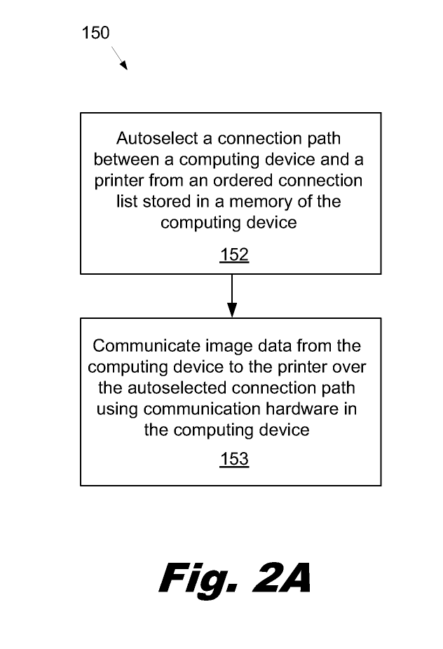

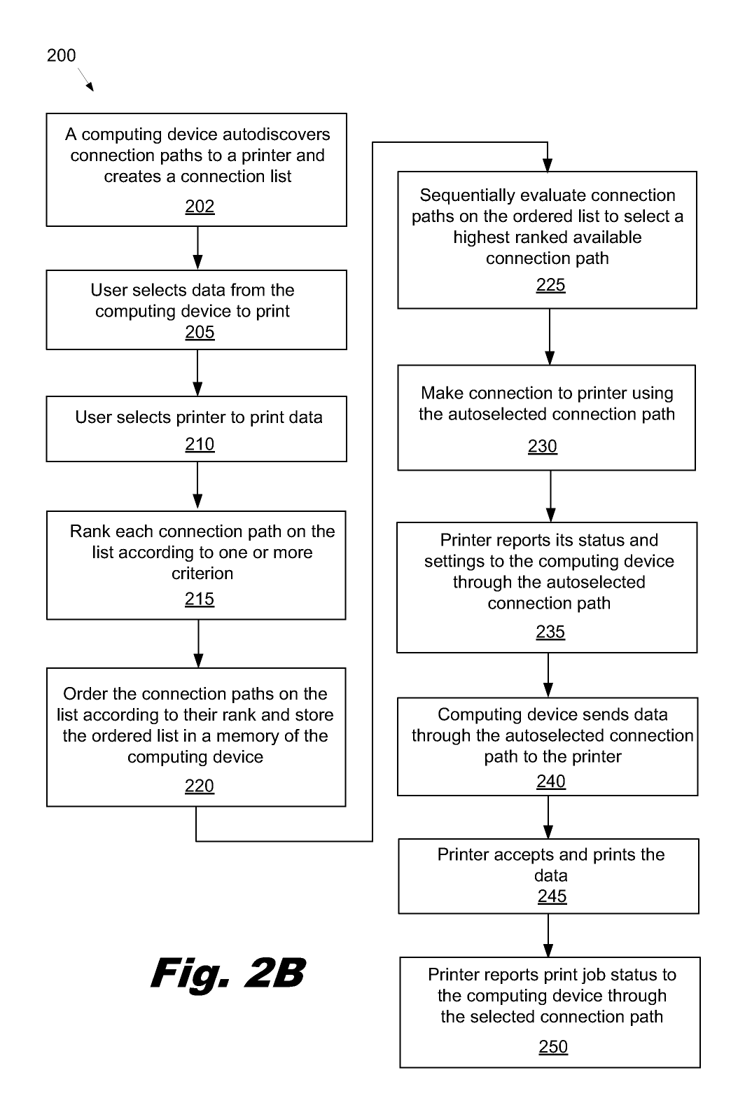

FIG. 2A is a flowchart of an illustrative method (150) for installing a printer and printing to the printer using an automatically selected connection path. As shown in FIG. 2A, the method begins with autoselecting a connection path between a computing device and a printer from an ordered connection list that is stored in a memory of the computing device (block 152). After the connection path is selected, the method (150) is completed by communicating image data from the computing device to the printer over the autoselected connection path using communication hardware in the computing device (block 153).

FIG. 2B is also so flowchart of an illustrative method (200) for installing a printer and printing to the printer using an automatically selected connection path. The computing device evaluates available connection paths to the printer and selects a “best” connection path to the printer. In general, the “best” connection to a target printer is the highest ranked connection that is available.

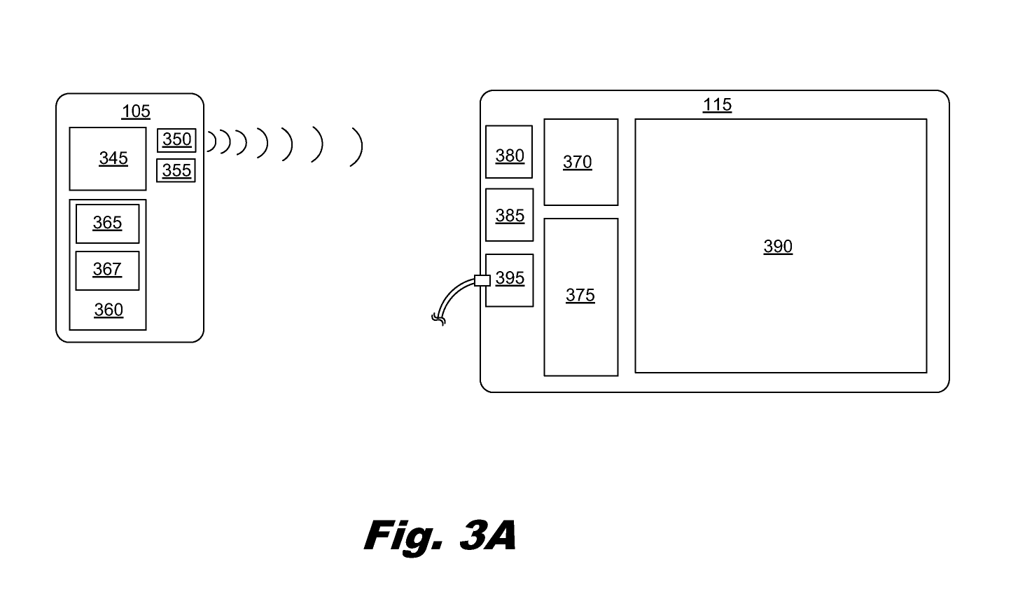

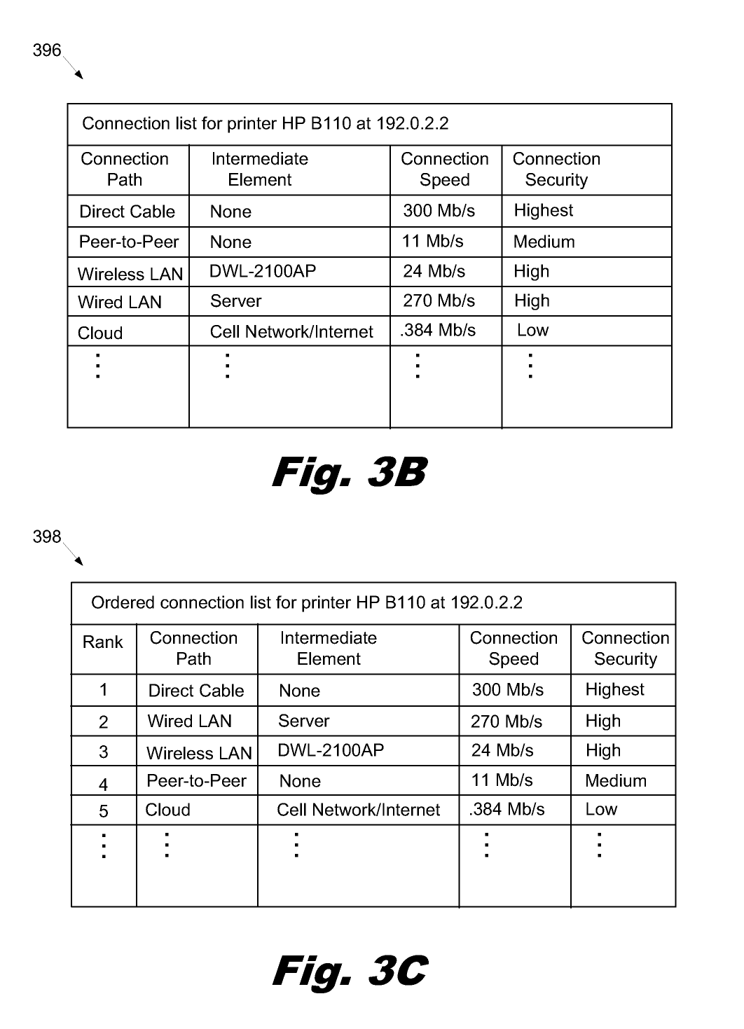

The computing device autodiscovers connection paths to the target printer and creates a connection list (block 202). An illustrative connection list is shown in FIG. 3B. The user selects data from the computing device to print (205) and selects a target printer to print the data (block 210). The user may select the data and printer in a variety of ways, including dragging and dropping a file onto a printer icon, attaching a file to an email sent to the printer, using drop down menus from within an application, or other techniques.

Each connection path on the connection list is ranked according to one or more criteria (block 215). The ranking can include a variety of factors including, but not limited to, the data transfer speed of the connection, the security of the connection, or cost of transmitting data over the connection. A variety of other factors may also be considered, such as the user's preferences, past connection behavior, the alphanumeric nature of the connection path identifier or other factors. Once rankings are assigned to the connection paths, the rankings can be modified based on a variety of considerations, including user directed modifications, changing user preferences, usage patterns, or change in geographic location.

The connection paths on the list are then ordered according to their rank to produce an ordered list that is stored in a memory of the computing device (block 220). In response to the print request, the computing device accesses the ordered list to sequentially evaluate the possible connection paths and selected a highest ranked connection path (block 225). The sequential evaluation of the listed connection paths proceeds according to ranking, with the connection paths being evaluated beginning with the highest ranked connection path. The computing device determines if the highest ranked connection path is available. For example, the computing device may request the printer to supply its status through the highest ranked connection path to determine if the highest ranked connection path is available. If the highest ranked connection path is available, the computing device makes a connection to the printer using the highest ranked connection path. If the highest ranked connection path is not available, the computing device sequentially evaluates connection paths that are lower on the list and determine if they are available. This autoselection of the connection paths stops when a viable connection is identified. If none of the connection paths on the connection list are available, the computing device reports to the user that a connection cannot be made to the printer.

The printer reports its status and settings to the computing device through the autoselected connection path (block 235). The computing device sends the data through the autoselected connection path to the printer (block 240). For example, the computing device could send an image, a combination of text and images, an email attachment, or other data. The printer accepts the data and prints the data (block 245). The printer reports the job status to the computing device through the autoselected connection path (block 250).

FIG. 3A is a diagram of various components within an illustrative computing device (105) and printer (115). The illustrative computing device (105) and printer (115) have the capabilities to implement the methods discussed above. The computing device (105) includes a processor (345), a memory (360) and communication hardware (350, 355). As discussed above, the memory (360) stores data including an ordered list (365) of potential connection paths to the printer (115) and image data (367). The processor (345) accesses the memory (360) to retrieve data such as operating instructions and the ordered list (365). The processor (345) executes the operating instructions and performs the method described in FIG. 3A. Specifically, the processor (345) may generate the ordered list, retrieve the ordered list, evaluated available connection paths to the printer, select a “best” connection to the printer using the ordered list, make a connection to the printer, and send the image data (367) to the printer (115). The communication hardware (350, 355) may include hardware that supports a variety of wireless or wired connections that enable network, peer-to-peer, and/or cloud connectivity.

The printer (115) includes communication hardware (380, 385, 390), a processor (370), a memory (375) and printer hardware (390). Similar to the computing device, the communication hardware (380, 385, 390) in the printer supports a variety of wireless or wired connections that enable network, peer-to-peer, and/or cloud connectivity. The processor (370) performs a variety of operations including control of various aspects of the printer hardware (390) operation, accessing the memory (375), processing information received from the communication hardware (380, 385, 390), reporting the printer status and settings, and other operations. The memory (375) may store a variety of data including images to be printed, formatting information and communication data.

FIGS. 3B and 3C are illustrative examples of a connection list and an ordered connection list, respectively. FIG. 3B is an example of a connection list (396) of potential connection paths between a computing device and a printer. The connection list (396) may specify the printer using identifying information such as the Internet Protocol (IP) address of the printer, the name of the printer, the Media Access Control (MAC) address of the printer, the name of the network the printer is connected to, or other identifying information. In this example, the printer is identified by its name “HP B110” and its network IP address “192.0.2.2”.

The first column of the connection table (396) lists the connection type. As discussed above, a wide variety of connection types may be available. The number and type of connections paths can be influenced by a number of factors, including the capabilities and configuration of the computing device, the capabilities and configuration of the printer, the capabilities of the networks that connect the two devices. In this example, the connection paths include direct cabled connections such as those made using docking stations or USB protocols, peer-to-peer connections such as those made using ad-hoc wireless protocols, wired Local Area Network (LAN) connections, wireless LAN connections, and cloud connections. The examples given above are only illustrative. Some of the examples given above may not be available for all devices. Additional connection paths may also be available. For example, a wide variety of additional cloud paths may be available.

The second column of the connection list describes intermediate elements that may be used to make the connection. These intermediate elements may be identified in a variety of ways, including using MAC addresses, IP addresses, Uniform Resource Locators (URLs) or other appropriate identifiers. The connection speed of each connection is listed. The connection speed may be an estimate, a predetermined value or a measured value. The connection list also shows the security of the various connections. The connection speed, connection security, and other values on list may be modified as desired or may be static values.

FIG. 3C is an illustrative example of an ordered connection list (398). In this example, the connection list (398) includes a rank column that lists a rank of the various connection paths. As discussed above, the rank of the connection paths may account for a variety of factors, including connection speed, the connection security and other factors. In this example, the rank accounts for both the connection speed and the connection security. The highest ranked connection is a direct connection that has a connection speed of 300 Mb/s and a “highest” security ranking. However, this path may not be available when a user of a mobile device wants to print an image or document but wired connections are not conveniently available.

The information given in the illustrative connection tables above are only examples. In use, the connection table may contain information in a different format and omit or add to information. For example, the connection table may include information about the geographic availability of the various connection paths. The computing device could then access its Global Positioning System (GPS) location to determine that of the connection paths are likely to be available. The wired connections, ranked 1 and 2 in the ordered connection list (398), are available at very specific geographic locations, while the peer-to-peer and Wireless LAN connection paths may be available over a wider area. Cloud connection paths may be available over extended geographic areas where the mobile device has access to the internet through cellular networks or outside wireless access points.

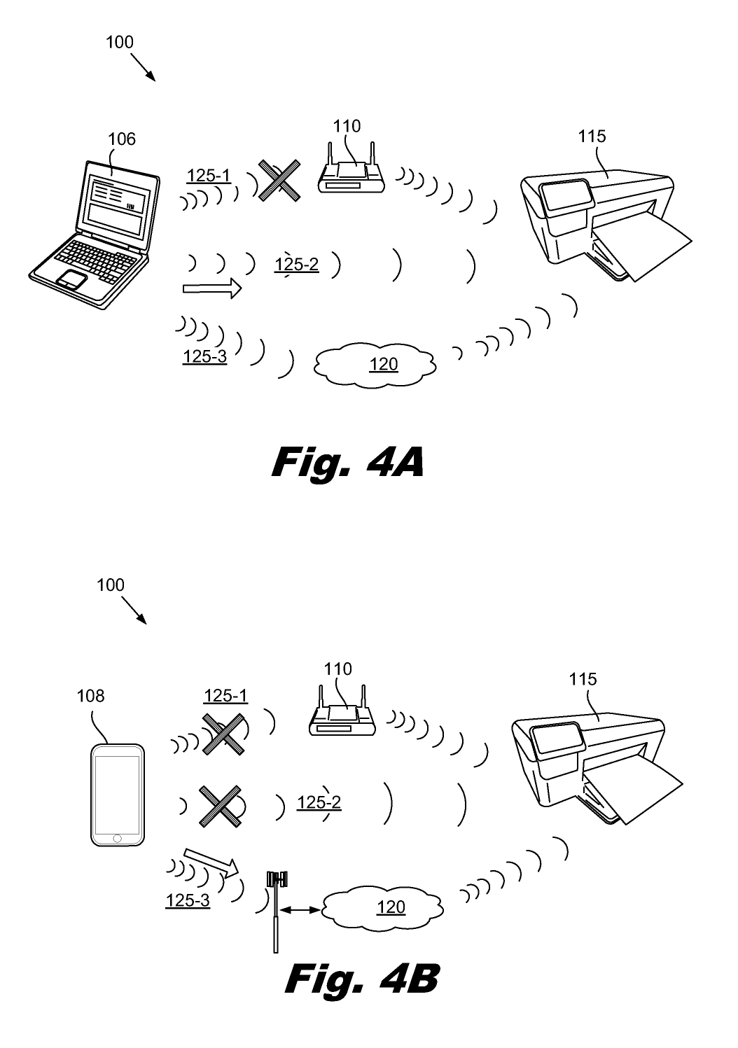

FIGS. 4A and 4B are illustrative examples of printing using an automatically selected connection path to a printer (115). FIG. 4A illustrates a guest computing device (106) that is carried by a visitor into an organization's wireless network. The visitor does not have access to the secured Wi-Fi network within the organization, but needs to print a boarding pass for a departing flight. Conventionally, the visitor has relatively few options. The visitor could request access to the Wi-Fi network. However, this can be cumbersome process and may be against the organization's policies. The visitor could email the boarding pass to a person within the organization who has access to the network and the printer. However, this is also inconvenient and time consuming.

With the autoselection of connection paths, the computing device (106) autodiscovers three available connection pathways to the printer (115) and creates a connection list. The computing device (106) then organizes the connection list according to one or more criteria. In this example, the computing device (106) uses communication speed as one of the criteria. The computing device (106) estimates that fastest connection is the Wi-Fi connection path (125-1), the second fastest connection is the peer-to-peer connection path (125-2) and the slowest connection is through the cloud connection path (125-3). The computing device (106) uses this information to order the connection list.

After the visitor has selected the boarding pass and designated the printer (115), the computing device (106) evaluates available connection paths to the printer (115). To do this, the computing device (106) accesses the ordered list of possible connection paths and queries the printer (115) for its status through the highest ranked connection path to determine if the highest ranked connection path is available. In this example, the fastest connection is the Wi-Fi connection. However, the computing device (106) is unable to make a connection to the Wi-Fi connection path (125-1) because the computing device (106) lacks the authentication credentials to connection the secured Wi-Fi network. Consequently, the computing device (106) evaluates the next connection path on the ordered list. In this case, the next connection path is the peer-to-peer connection path (125-2). The computing device (106) connects directly to the printer (115) using this peer-to-peer connection path (125-2) and communicates the image data to the printer (115). The printer (115) prints out (115) prints out the boarding pass and reports back to the computing device (115) that the printing was successful.

As discussed above, the autoselection of connection paths to the printer (115) may be entirely transparent to the user. For example, the user may simply select the data to be printed and the printer that is to do the printing. The computing device then follows the process described above and the boarding pass is printed.

FIG. 4B is another illustrative example of printing using an automatically selected connection path to a printer (115). In this example, the computing device is a mobile device (108). The mobile device (108) has been carried out of the range of Wi-Fi networks to which it is authorized to connect. The mobile phone (108) is also out of range of the peer-to-peer network connection path (125-2). The user instructs the mobile device (108) to print an image using the printer (115). To print to the printer (115), the mobile device (108) follows the same procedure described above. Specifically, the mobile device (108) accesses a connection list and evaluates the connection paths to determine the “best” connection to the printer (115). According to one illustrative example, the mobile device (108) walks down a ranked list of connections, starting with the highest ranked connection path and progressively moving to the connection path with the next highest ranking. The mobile device (108) sequentially evaluates each connection until it finds a viable connection. In this example, the Wi-Fi connection path (125-1) and the peer-to-peer connection path (125-2) are not available, but the cloud connection path (125-3) is available through a cellular network. This cloud connection path (125-3) may be both slow and expensive. The data that is transferred over the cellular network may consume a portion of the user's data allotment. If the user's data allotment has been exceeded, the user may end up paying additional costs for transferring the data. However, it is the only connection path available in this example. The mobile device (108) may communicate to the user that it has found a communication path to the printer (115) using a cellular network and ask the user if they want to send the image data to the printer using this connection path. If the user approves the request, the image data is sent through the cloud connection path (125-3) to the printer (115).

In summary, as electronic interaction advances, multiple print paths between computing devices to printers are being developed. It significantly complicates the user's experience to expect the user to understand and choose between different connection paths. User selection of connection paths can cause user confusion and frustration. Additionally, a user may consistently select only one connection path, which limits the printing solutions for the user.

The solution described above identifies multiple paths to a printer (such as direct, network, and cloud). To print, the user specifies the printer and the computing device automatically selects the “best” connection path to the printer. This solution makes it simple for the user to print and hides the complexity and routing from the user.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for autoselecting a print path comprises:
autoselecting a connection path between a computing device and a printer from an ordered connection list stored in a memory of the computing device; and
communicating image data from the computing device to the printer over the autoselected connection path using communication hardware in the computing device.

2. The method of claim 1, further comprising:
autodiscovery of connection paths between a computing device and a printer; and
creating a list comprising the connection paths.

3. The method of claim 2, further comprising ordering the connection paths in the list according to a rank to produce the ordered connection list, the ordered connection list being stored on a memory of the computing device.

4. The method of claim 3, in which ordering the connection paths comprises ranking the connection paths according to at least one of: connection speed, connection security and data transfer cost.

5. The method of claim 3, in which autoselecting a connection path comprises evaluating a highest ranked connection path in the ordered connection list to determine if the printer is available through the highest ranked connection path.

6. The method of claim 5, in which evaluating the highest ranked connection path comprises sending a status query from the computing device through the highest ranked connection path to the printer and waiting for a response from the printer which reports the printer status.

7. The method of claim 6, further comprising:
if the printer response to the status query through the highest ranked connection path indicates the highest ranked connection path is viable, then selecting the highest ranked connection path; and
communicating image data over the highest ranked connection path to the printer.

8. The method of claim 6, further comprising:
if there is no printer response to the status query through the highest ranked connection path, then sequentially evaluating lower ranked connection paths on the list; and
making a connection to an available connection path which has the highest ranking.

9. The method of claim 1, further comprising:
receiving the image data through the autoselected connection path; and
printing the image data.

10. The method of claim 8, further comprising if none of the connections listed on the ordered connection list are available, then sending a notification to the user that a connection cannot be made to the printer.

11. The method of claim 1, in which creating a connection list of the available connection paths comprises:
accessing GPS coordinates of the computing device; and
eliminating connection paths from the connection list which are not available at the GPS coordinates of the computing device.

12. The method of claim 7, in which communicating image data over the highest ranked connection path to the printer comprises sending an email attachment to the printer.

13. The method of claim 7, in which the highest ranked connection path is through non-analogous networks.

14. The method of claim 1, in which the ordered connection list comprises a plurality of connection paths through non-analogous networks.

15. The method of claim 1, further comprising:
selecting data stored in the memory of the computing device to print; and
selecting a target printer.

16. A method for installing and printing to a printer comprises:
autodiscovery of connection paths between a computing device and the printer;
creating a connection list of the connection paths;
ordering the connection paths in the connection list according to a rank to produce the ordered connection list, the ordered connection list being stored on a memory of the computing device;
selecting image data stored in the memory of the computing device to print;
selecting a target printer;
autoselecting a connection path between the computing device and the printer from the ordered connection list, in which autoselecting the connection path comprises sequentially evaluating connection paths on the ordered connection list to select a highest ranked available connection path;
communicating image data from the computing device to the printer over the autoselected connection path using communication hardware;
receiving the image data by the printer through the autoselected connection path; and
printing the image data.

17. A computing device comprising:
a memory;
image data stored in the memory;
an ordered list of connection paths to a printer stored in the memory;
a processor for accessing the ordered list of connection paths to the printer and for autoselecting a connection path to the printer from the ordered list of connection paths; and
communication hardware for transmitting the image data through the autoselected connection path to the printer.

18. The device of claim 17, in which the ordered list of connection paths comprises connection paths through non-analogous networks.

19. The device of claim 17, in which the ordered list is generated by the processor and ranked according to at least one of: connection speed, security, and cost.

20. The device of claim 17, in which autoselecting the connection path comprises sequentially evaluating connection paths on the ordered connection list by sending a status request to the printer through the autoselected connection path to the printer using the communication hardware.
